(19) United States
(12) Patent Application Publication
(10) Pub. No.: US 2010/0211208 A1
(43) Pub. Date: Aug. 19, 2010

(54) CUTTING APPARATUS AND CUTTING METHOD USING THE SAME

(75) Inventor: Jhy-Hau Chiu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/417,618

(22) Filed: Apr. 2, 2009

(30) Foreign Application Priority Data
Feb. 19, 2009 (CN) 200910300484.0

(51) Int. Cl. G06F 19/00; B26D 5/00

(52) U.S. Cl. 700/169; 700/179; 83/76.1

(57) ABSTRACT

A cutting apparatus includes a cutting tool program control module configured for controlling a number of cutting tools to cut an element. The cutting tool program control module includes a cutting tool program storing unit, a cutting tool program selecting unit, and a cutting tool program executing unit. The cutting tool program storing unit stores a number of cutting tool programs for controlling the number of cutting tools accordingly. The cutting tool program selecting unit selects one or more cutting tool programs and stores corresponding selecting information according to the selected cutting tool programs. The cutting tool program executing unit executes the selected cutting tool programs according to the selecting information stored in the cutting tool program selecting unit.

### BACKGROUND

1. Technical Field

The present disclosure relates to cutting apparatuses and cutting methods, and particularly to a cutting apparatus and a cutting method for cutting an element completely.

2. Description of Related Art

In cutting operation processes, elements are cut by cutting tools of cutting apparatuses. Sometimes, a cutting operation process needs to use a lot of different cutting tools to cut an element, such as using a first cutting tool to drill holes of the element, and using a second cutting tool to cut sides of the element, and so on. However, the cutting tools may subject to damages during the cutting operation process due to aging or other reasons. As a result, the element may not be cut completely and become an incomplete element or a semi-finished product.

For completing the incomplete element, there are two related-art methods. A first related-art method is to amend a cutting operation program to cut the incompleted element, however this method requires users to have a full understanding of the cutting operation program. A second related-art method is to use a manual operation to cut the incompleted element, which is unduly laborious and time-consuming.

### BRIEF DESCRIPTION OF THE DRAWINGS

FIG. 1 is a block diagram of an exemplary embodiment of a cutting tool program control module of a cutting apparatus.

FIG. 2 is a schematic view of an exemplary embodiment of a cutting tool program selecting window of the cutting apparatus of FIG. 1.

FIG. 3 is a flowchart of an exemplary embodiment of a cutting method.

### DETAILED DESCRIPTION

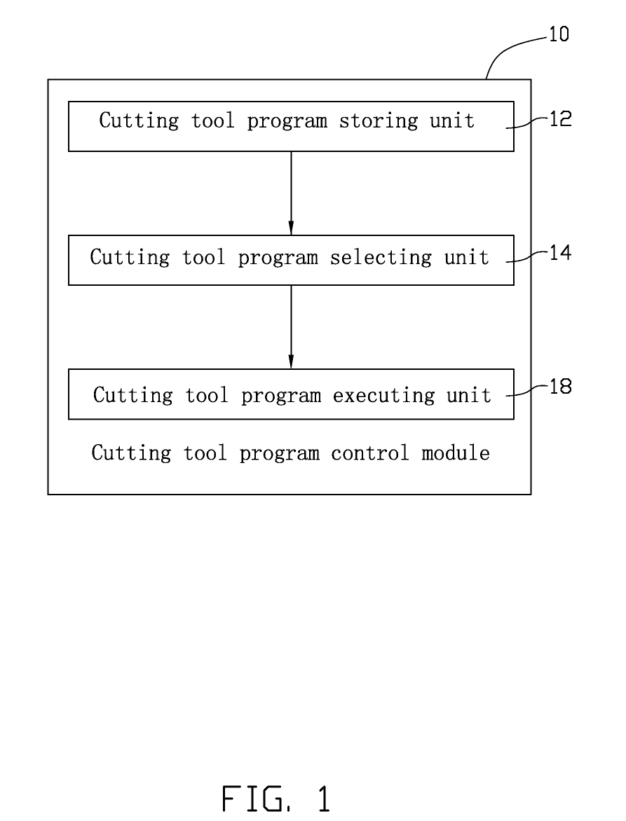

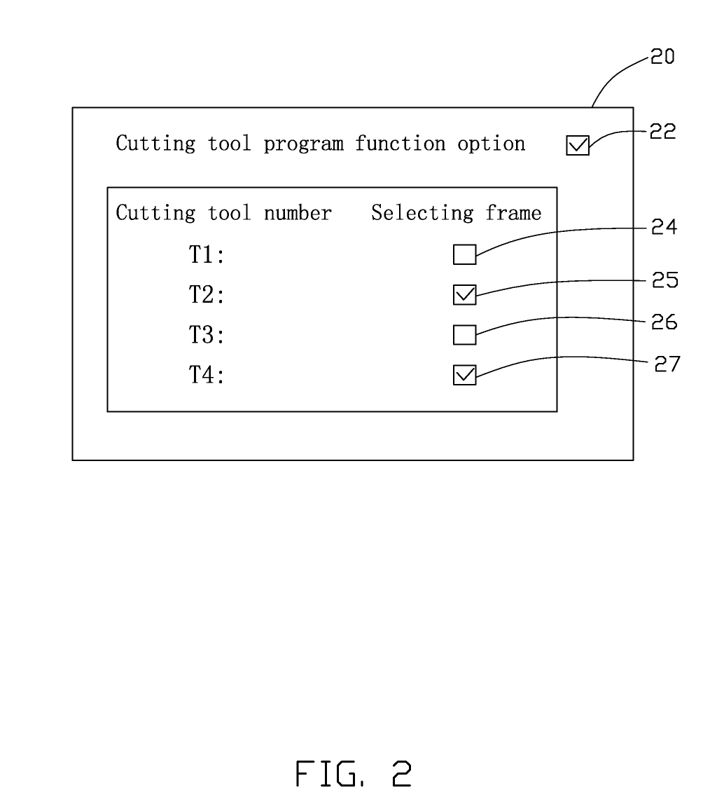

Referring to FIGS. 1 and 2, an exemplary embodiment of a cutting apparatus is configured for cutting an element such as a printed circuit board (PCB). The cutting apparatus includes a cutting tool program control module 10 configured for controlling four cutting tools to cut the element, corresponding to four cutting tool numbers (T1-T4 in FIG. 2) in one embodiment. In other embodiments, the number of the cutting tools can be adjusted according to need.

The cutting tool program control module 10 includes a cutting tool program storing unit 12, a cutting tool program selecting unit 14, and a cutting tool program executing unit 18. The cutting tool program storing unit 12 is configured for storing four cutting tool programs for controlling the four cutting tools accordingly. The cutting tool program selecting unit 14 is configured for selecting one or more cutting tool programs and storing corresponding selecting information according to the selected cutting tool programs. The cutting tool program executing unit 18 is configured for reading all of the four cutting tool programs and executing the selected cutting tool programs according to the selecting information stored in the cutting tool program selecting unit 14.

As shown in FIG. 2, the cutting apparatus further includes a cutting tool program selecting window 20 corresponding to the cutting tool program selecting unit 14. The cutting tool program selecting window 20 includes a cutting tool program function option 22, four cutting tool numbers T1-T4 corresponding to the four cutting tool programs, and four selecting frames 24-27 corresponding to the four cutting tool numbers T1-T4. When the cutting tool program function option 22 is selected, the cutting tool program selecting unit 14 starts to work. When one of the four selecting frames 24-27 is selected, the corresponding cutting tool program is selected by the cutting tool program selecting unit 14.

When one or more of the four cutting tools are broken during the cutting process, the element cannot be completely cut. When the cutting process is over, the broken tools are replaced by new ones. After that, the cutting tool program function option 22 of the cutting tool program selecting window 20 is selected to start the cutting tool program selecting unit 14 to rework the incomplete element. One or more of the four selecting frames 24-27 of the cutting tool program selecting window 20 are selected corresponding to the one or more broken cutting tools. For example, if the numbers of the replaced new cutting tools is T2 and T4, two corresponding selecting frames 25 and 27 of the cutting tool program selecting window 20 are selected. At the same time, the cutting tool program selecting unit 14 stores the above-mentioned selecting information. In a reworking cutting process, the cutting tool program executing unit 18 executes the two corresponding cutting tool programs stored in the cutting tool program storing unit 12 according to selecting information, therefore the reworking cutting process is very convenient.

In a normal cutting process, the four cutting tools T1-T4 are all in good conditions, therefore the cutting tool program function option 22 of the cutting tool program selecting window 20 needs not to be selected. At this time, the four selecting frames 24-27 of the cutting tool program selecting window 20 is invalid, which means the four selecting frames can not be selected. The cutting tool program executing unit 18 executes all of the four cutting tool programs stored in the cutting tool program storing unit 12 according to a predetermined order.

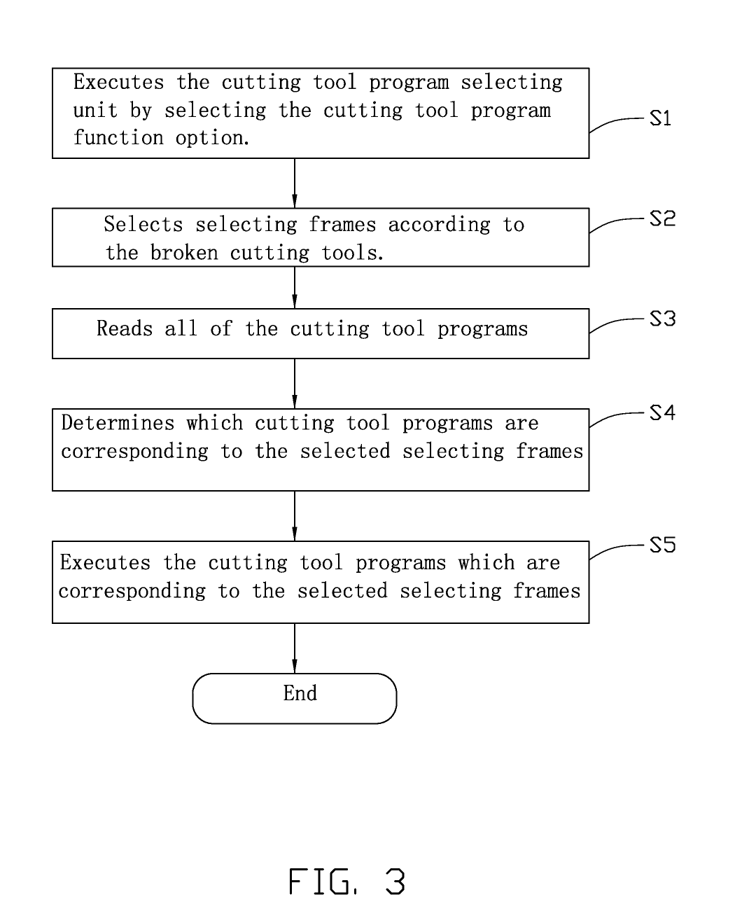

Referring to FIG. 3, an exemplary embodiment of a cutting method using the above-mentioned cutting apparatus to cut an incompleted element in a reworking cutting process includes the following steps.

In step S1, the cutting tool program selecting unit 14 is used for selecting the cutting tool program function option 22 of the cutting tool program selecting window 20. In other embodiments, the cutting tool program selecting unit 14 can be executed by other methods.

In step S2, one or more of the four selecting frames 24-27 of the cutting tool program selecting window 20 are selected according to one or more broken cutting tools. At the same time, the cutting tool program selecting unit 14 stores the above-mentioned selecting information.

In step S3, the cutting tool program executing unit 18 reads all of the four cutting tool programs stored in the cutting tool program storing unit 12 according to a predetermined order.

In step S4, the cutting tool program executing unit 18 determines which one or more of the four cutting tool programs are corresponding to the selected one or more of the selecting frames 24-27 of the cutting tool program selecting window 20.

In step S5, the cutting tool program executing unit 18 executes the one or more read cutting tool programs which are corresponding to the selected one or more of the selecting frames 24-27 of the cutting tool program selecting window 20.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A cutting apparatus for an element, comprising:
a cutting tool program control module configured for controlling a plurality of cutting tools to cut the element, the cutting tool program control module comprising:
a cutting tool program storing unit to store a plurality of cutting tool programs for controlling the plurality of cutting tools accordingly;
a cutting tool program selecting unit to select one or more cutting tool programs and storing corresponding selecting information according to the selected cutting tool programs; and
a cutting tool program executing unit to execute the selected cutting tool programs according to the selecting information stored in the cutting tool program selecting unit.

2. The cutting apparatus of claim 1, wherein the cutting tool program control module further comprises a cutting tool program selecting window corresponding to the cutting tool program selecting unit, the cutting tool program selecting unit is capable of selecting the one or more cutting tool programs via the cutting tool program selecting window.

3. The cutting apparatus of claim 2, wherein the cutting tool program selecting window comprises a cutting tool program function option, a plurality of cutting tool numbers corresponding to the plurality of cutting tool programs, and a plurality of selecting frames corresponding to the plurality of cutting tool numbers, wherein the cutting tool program selecting unit starts to work in response to the cutting tool program function option being selected, the one or more corresponding cutting tool programs are selected for the cutting tool program selecting unit in response to one or more selecting frames being selected.

4. A cutting method for cutting an element, the cutting method comprising:
starting a cutting tool program selecting unit by selecting its cutting tool program function option;
selecting one or more cutting tool programs of a plurality of cutting tool programs stored in a cutting tool program storing unit and storing corresponding selecting information according to the selected one or more cutting tool programs;
reading all of cutting tool programs stored in the cutting tool program storing unit;
determining which one or more of the all cutting tool programs are the one or more selected cutting tool programs; and
executing the one or more selected cutting tool programs.

5. The cutting method of claim 4, wherein the cutting tool program control module further comprises a cutting tool program selecting window corresponding to the cutting tool program selecting unit, the cutting tool program selecting unit is capable of selecting the one or more cutting tool programs via the cutting tool program selecting window.

6. The cutting method of claim 5, wherein the cutting tool program selecting window comprises the cutting tool program function option, a plurality of cutting tool numbers corresponding to the plurality of cutting tool programs, and a plurality of selecting frames corresponding to the plurality of cutting tool numbers, wherein the cutting tool program selecting unit starts to work in response to the cutting tool program function option being selected, one or more corresponding cutting tool programs are selected for the cutting tool program selecting unit in response to one or more of the selecting frames being selected.
